(19) United States
(12) Patent Application Publication
(10) Pub. No.: US 2007/0166642 A1
(43) Pub. Date: Jul. 19, 2007

(54) Photosensitive resin composition, and cured product and use thereof

(75) Inventor: Hirofumi Inoue, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., MINATO-KU TOKYO (JP)

(21) Appl. No.: 11/579,920

(22) PCT Filed: May 25, 2005
(86) PCT No.: PCT/JP05/09999

§ 371 Date: Nov. 8, 2006

Related U.S. Application Data
(60) Provisional application No. 60/576,030, filed on Jun. 2, 2004.

(30) Foreign Application Priority Data
May 26, 2004 (JP) 2004-156492

(51) Int. Cl. G03C 1/00

(52) U.S. Cl. 430/270.1

(57) ABSTRACT

The invention relates to a photosensitive resin composition comprising (A) an epoxy(meth)acrylate resin synthesized from components containing (a) epoxy prepolymer, (b) an unsaturated group-containing monocarboxylic acid and (c) an acid anhydride, (B) a urethane (meth)acrylate resin synthesized from components containing (d) a dihydroxyl compound having a carboxyl group, (e) a polyol compound having an number average molecular weight of 200 to 20,000, (f) a hydroxyl compound having a (meth)acryloyl group and (g) diisocyanate compound, (C) an epoxy resin, (D) a diluent, (E) a photopolymerization initiator and if appropriate (F) inorganic ion exchanger, and cured product and use thereof. The photosensitive resin composition of the invention having good photosensitivity, developability, flexibility and property exhibiting excellent HHBT performance can be suitably used in printed circuit boards.

### CROSS-REFERENCE TO RELATED APPLICATIONS

This is an application filed pursuant to 35 U.S.C. Section 111(a) with claiming the benefit of U.S. provisional application Ser. No. 60/576,030 filed Jun. 2, 2004 under the provision of 35 U.S.C. 111(b), pursuant to 35 U.S.C. Section 119(e)(1).

### TECHNICAL FIELD

The present invention relates to a photosensitive resin composition for protective coating film such as solder resist on a printed circuit board, and cured product and use of the composition.

### Background Art

A printed circuit board consists of a substrate such as polyimide film, phenolic resin laminate and glass epoxy resin coated board, a copper foil forming a circuit and a protective film mainly comprising acrylic epoxy resin and the like.

In many cases of producing printed circuit boards, photosensitive resin compositions using UV-curing resin are employed for the purpose of saving natural resources and energy, and enhancing operating efficiency and productivity. Recently, with the downsizing of electronic devices, flexible circuit boards are used in many cases. In the technological field of the flexible circuit board where higher density is required with the progress in the downsizing of electronic devices, there are rising problems relating to disorder and performance deterioration due to a phenomenon called migration on circuit boards caused by decrease in the distance between electrodes.

As photosensitive resin composition for flexible circuit boards, for example, resin composition comprising carboxy-modified urethane acrylate and alkali-soluble polymer such as copolymer of acrylic acids and cellulose polymer (JP-A-H8-54734), and resin composition comprising a carboxyl group containing polymer and a urethane acrylate of a polyether polyol and/or polyester polyol(JP-A-2003-345006) are proposed. However, these resin compositions do not have sufficient resistance to hydrolysis and do not achieve satisfactory performance in high temperature/high humidity bias testing (hereinafter, referred to simply as “HHBT performance”.)

Moreover, JP-A-2002-293882 discloses photo-curable and heat-curable resin composition containing epoxy butadiene and urethane fine particles for the purpose of flexibility. However, this resin composition, reduced in heat-resistance and developability, does not have satisfactory properties.

### Disclosure of the Invention

Accordingly, the object of the present invention is to solve the above problems remaining in conventional techniques for printed circuit boards by providing a photosensitive resin composition having good flexibility and excellent HHBT performance without detriment to other properties required for a circuit board.

As a result of extensive studies made in order to solve the problems, the present inventors have found that a photosensitive resin composition having good flexibility and excellent HHBT performance can be obtained by using a specific epoxy (meth)acrylate resin and a urethane (meth)acrylate resin, and thus completed the invention.

That is, the present invention relates to a photosensitive resin composition, a resist ink containing the photosensitive resin composition, a heat-cured product of the photosensitive resin composition, a solder resist comprising the cured product and a printed circuit board partially or wholly coated with the cured product.
1. A photosensitive resin composition comprising
(A) an epoxy(meth)acrylate resin synthesized from components containing (a) epoxy prepolymer, (b) an unsaturated group-containing monocarboxylic acid and (c) an acid anhydride,
(B) a urethane(meth)acrylate resin synthesized from components containing (d) a dihydroxyl compound having a carboxyl group, (e) a polyol compound having an number average molecular weight of 200 to 20,000, (f) a hydroxyl compound having a (meth)acryloyl group and (g) diisocyanate compound,
(C) an epoxy resin,
(D) a diluent and
(E) a photopolymerization initiator.
2. The photosensitive resin composition as described in 1, further comprising (F) an inorganic ion exchanger.
3. The photosensitive resin composition as described in 1, wherein the blending ratios of the components in the composition are 10 to 90 mass % for component (A), 1 to 60 mass % for component (B), 3 to 40 mass % for component (C) and 5 to 80 mass % for component (D).
4. The photosensitive resin composition as described in 1 or 2, wherein the acid value of the epoxy(meth)acrylate resin (A) is in a range of 5 to 150 mgKOH/g and the weight average molecular weight of the epoxy(meth)acrylate resin (A) is in a range of 1,000 to 100,000.
5. The photosensitive resin composition as described in 1 or 2, wherein the acid value of the urethane (meth) acrylate resin (B) is in a range of 5 to 150 mgKOH/g and the weight average molecular weight the epoxy(meth)acrylate resin (B) is in a range of 1,000 to 100,000.
6. The photosensitive resin composition as described in 1 or 2, wherein the acid anhydride (c) contained in the epoxy(meth)acrylate resin (A) is tetrahydrophthalic anhydride.
7. The photosensitive resin composition as described in 1 or 2, wherein the dihydroxyl compound having a carboxyl group (d) contained in the urethane(meth)acrylate resin (B) is dimethylol butanoic acid.
8. The photosensitive resin composition as described in 1 or 2, wherein the polyol compound (e) contained in the urethane (meth)acrylate resin (B) is a polycarbonate diol.
9. The photosensitive resin composition as described in 1 or 2, wherein the epoxy resin (C) has two or more epoxy groups in one molecule.
10. The photosensitive resin composition as described in 1 or 2, wherein the viscosity at 25° C. is in a range of 0.5 to 500 Pa·s.
11. A heat-cured product of the photosensitive resin composition described in any one of 1 to 10.
12. A solder resist comprising the heat-cured product described in 11.
13. A printed circuit board partially or wholly coated with the heat-cured product described in 11.
14. A resist ink comprising the photosensitive resin composition described in any one of 1 to 10.

### DETAILED DESCRIPTION OF THE INVENTION

Hereinafter, the present invention is described in detail.

The epoxy(meth)acrylate resin (A) used in the present invention (hereinafter, sometimes simply referred to as “component (A)”) is synthesized from components containing (a) epoxy prepolymer, (b) unsaturated group containing monocarboxylic acid and (c) acid anhydride.

A compound serving as (a) epoxy prepolymer can be obtained by reacting an alcoholic hydroxyl group of an epoxy compound such as bisphenol A-type epoxy compound, bisphenol F-type epoxy compound, bisphenol S-type epoxy compound, phenol novolak epoxy compound, cresol novolak epoxy compound, or aliphatic epoxy compound with epihalohydrin such as epichlorohydrin, preferably in the presence of dimethylsulfoxide. The epihalohydrin may be used in an equivalence ratio of 1 or more epihalohydrin to alcoholic hydroxyl group. However, in a case where the epihalohydrin is used in an equivalence ratio of 15 or more to alcoholic hydroxyl group, little effect commensurate with the increase in the amount can be obtained and volume efficiency is reduced.

In a case where dimethylsulfoxide is used, the amount is preferably 5 to 300% by mass based on the amount of the epoxy compound. If the amount of dimethylsulfoxide is less than 5% by mass, the reaction rate is low and therefore the reaction requires a long period of time. On the other hand, if the amount exceeds 300% by mass, there is no increase in effects which is commensurate with the excess and volume efficiency is reduced.

In conducting the reaction, an alkali metal hydroxide is used. Examples of alkali metal hydroxide usable in the present invention include caustic soda, caustic potash, lithium hydroxide and calcium hydroxide, and among these, caustic soda is preferable. The amount of the alkali metal hydroxide may be about 1 equivalent to 1 equivalent of the alcoholic hydroxyl group of the epoxy compound. In a case where the whole amount of alcoholic hydroxyl group of the epoxy compound is to be epoxidized, the alkali metal hydroxide may be used in an excessive amount, however, if the amount is an amount exceeding 2 equivalent to 1 equivalent of the alcoholic hydroxyl group, polymerization tends to take place to some degree.

The alkali metal hydroxide may be used either in form of solid or an aqueous solution. In a case where the alkali metal hydroxide is used as an aqueous solution, the reaction may be conducted while removing water from the reaction system under a normal or reduced pressure during the reaction time. The reaction temperature is preferably from 30 to 100° C. If the reaction temperature is less than 30° C., the reaction rate is low and the reaction takes a long period of time. On the other hand, if the temperature exceeds 100° C., it is not preferred since a side reaction occurs increasingly.

After completion of the reaction, excessive epihalohydrin and dimethyl sulfoxide may be removed under reduced pressure. Subsequently, resin generated by the reaction may be dissolved in an organic solvent to conduct dehydrohalogenation using alkali metal hydroxide. Alternatively, after completion of the reaction, by-produced salts and dimethylsulfoxide may be separated by washing with water, and excessive epihalohydrin may be removed from the oil layer under reduced pressure. Subsequently, resin may be dissolved in an organic solvent to conduct dehydrohalogenation using alkali metal hydroxide. Examples of organic solvent usable in the present invention include methylisobutylketone, benzene, toluene and xylene, and among these, methylisobutylketone is preferred. Also, these organic solvents may be used singly or may be used in a mixture of two or more.

Examples of (b) unsaturated group containing monocarboxylic acid include acrylic acid, a dimer of acrylic acid, methacryl acid, β-styrylacrylic acid, β-furfuryl acrylic acid, crotonic acid, α-cyano cinnamic acid, cinnamic acid, a half ester which is a reaction product between a saturated or unsaturated dibasic acid anhydride and a (meth)acrylate derivative having one hydroxyl group in one molecule and a half ester which is a reaction product between a saturated or unsaturated dibasic acid anhydride and an unsaturated group-containing monoglycidyl compound. Examples of the half ester include half esters obtained by reacting unsaturated or saturated dibasic acid such as succinic acid anhydride, maleinic acid anhydride, phthalic acid anhydride, tetrahydrophthalic acid anhydride, hexahydrophthalic acid anhydride, methylhexahydrofutalic acid anhydride, methyltetrahydrophthalic acid, itaconic acid anhydride, or methylendomethylenetetrahydrophthalic acid anhydride with a (meth)acrylate derivative having one hydroxyl group in one molecule such as hydroxyethyl (meth)acrylate, hydroxypropyl (meth)acrylate, hydroxybutyl (meth)acrylate, polyethyleneglycol mono(meth)acrylate, glycerine di(meth)acrylate, trimethylolpropane di(meth)acrylate, pentaerythritol tri(meth)acrylate, dipentaerythritol penta(meth)acrylate or phenylglycidylether (meth)acrylate in equimolar amounts or half esters obtained by reacting a saturated or unsaturated dibasic acid (such as succinic acid, maleic acid, adipic acid, phthalic acid, tetrahydrophthalic acid, hexahydrophthalic acid, itaconic acid and fumaric acid) with an unsaturated group-containing monoglycidyl compound (such as glycidyl (meth)acrylate) in equimolar amounts. These half esters may be used singly or two or more of them may be used in a mixture. Among them, particularly preferred is acrylic acid.

Examples of (c) acid anhydride include dibasic acid anhydride such as maleic acid anhydride, succinic acid anhydride, itaconic acid anhydride, phthalic acid anhydride, tetrahydrophthalic acid anhydride, hexahydrophthalic acid anhydride, methylhexahydrophthalic acid anhydride, endomethylenetetrahydrophthalic acid anhydride, methylendomethylenetetrahydrophthalic acid anhydride, chlorende acid anhydride and methyltetrahydrophthalic acid anhydride, aromatic polyvalent carboxylic acid anhydride such as trimerit acid anhydride, pyromerit acid anhydride and benzophenonetetracarboxylic acid dianhydride, 5-(2,5-dioxotetrahydrofuryl)-3-methyl-3-cyclohexene-1,2-dicarboxylic acid anhydride and endobicyclo-[2,2,1]-hept-5-en-2,3-dicarboxylic acid anhydride. Among them, tetrahydrophthalic acid anhydride is particularly preferred.

Component (A) is obtained by first reacting (a)epoxy prepolymer with (b) unsaturated group-containing carboxylic acid and then reacting the addition reaction product with (c) acid anhydride.

In the first reaction, it is preferable that (b) unsaturated group-containing carboxylic acid be used in an amount of about 0.8 to 1.3 equivalent based on 1 equivalent of (a)epoxy prepolymer, and more preferably about 0.9 to 1.1 equivalent. Upon reaction, it is preferable that diluent, for example, ketones such as ethyl methyl ketone and cyclohexanone, aromatic hydrocarbons such as toluene, xylene and tetramethylbenzene, glucol ethers such as dipropyleneglycol dimethyl ether and dipropyleneglycol diethyl ether, esters such as ethyl acetate, butyl acetate, butylcellosolve acetate and carbitol acetate, aliphatic hydrocarbons such as octane and decane, organic solvents such as petroleum solvents such as petroleum ether, petroleum naphtha, hydrogenated petroleum naphtha and solvent naphtha be used, or that diluent doubling as solvent, for example, reactive monomers such as carbitol(meth)acrylate, phenoxyethyl(meth)acrylate, pentaerythritol tetra(meth)acrylate, trimethylolpropane tri(meth)acrylate, tris(hydroxyethyl)isocyanurate tri(meth)acrylate and dipentaerythritol hexa(meth)acrylate be used.

Further, for the purpose of accelerating the reaction, it is preferable that catalyst (such as triethylamine, benzyldimethylamine, methyltriethylammonium chloride, benzyltrimethylammonium bromide, benzyltrimethylammonium iodide, triphenylphosphine, triphenylstibine, chromium octanoate and zirconium octanoate) be used. The amount of the catalyst used is preferably 0.1 to 10 mass % based on the amount of the mixture of reaction materials.

Furthermore, for the purpose of prevention polymerization during the reaction, it is preferable that polymerization inhibitor (such as hydroquinone, methylhydroquinone, hydroquinone monomethyl ether, cathecol and pyrogallol) be used. The amount of the polymerization inhibitor used is preferably 0.01 to 1 mass % based on the amount of the mixture of reaction materials.

The reaction temperature is preferably 60 to 150° C. The reaction time is preferably 5 to 60 hours.

Next, the addition reaction product is reacted with (c) acid anhydride. In this reaction, it is preferable that acid anhydride (c) be used in an amount of 0.1 to 0.9 equivalent based on 1 equivalent of hydroxyl group present in the addition reaction product. The reaction temperature is preferably 60 to 150° C. The reaction time is preferably 1 to 10 hours.

It is preferable that the weight average molecular weight of thus obtained epoxy(meth)acrylate resin (A) be 1,000 to 100,000, more preferably 3,000 to 30,000. If the weight average molecular weight is less than 1,000, strechability, flexibility and strength of a cured film may be deteriorated. On the other hand, if it exceeds 100,000, it may cause reduction in curability and developability due to ultraviolet ray, which is not preferred.

The weight average molecular weight is a value in terms of polystyrene, measured by using gel permeation chromatography.

Moreover, it is preferable that the acid value of component (A) be 5 to 150 mgKOH/g, more preferably 30 to 120 mgKOH/g. If the acid value is less than 5 mgKOH/g, reactivity with curable components may decrease, resulting in deterioration of heat resistance. On the other hand, if it exceeds 150 mg KOH/g, properties such as alkali resistance and electric properties of the cured film may decrease. Component (A) may be used singly or two or more kinds may be used in combination.

The blending amount of component (A) is preferably 10 to 90 mass % in the composition, more preferably 15 to 80 mass %. If the amount of component (A) is less than 10 mass %, it may lead to insufficient heat resistance and flexibility of the cured film. On the other hand, if it exceeds 90 mass %, it may lead to decrease in flexibility and solvent resistance of the cured film.

In the present invention, urethane(meth)acrylateresin(B) (hereinafter, sometimes referred to as “component(B)”) is synthesized from components containing (d)dihydroxyl compound having carboxyl group, (e) polyol compound having a number average molecular weight of 200 to 20,000, (f) hydroxyl compound having (meth)acryloyl group and (g) diisocyanate compound.

Examples of (d) dihydroxyl compound having carboxyl group include a branched or straight chain compound having one carboxyl group and two alcoholic hydroxyl group. Particularly, dihydroxy aliphatic carboxylic acid having carboxyl group is preferably used. Preferred examples of (d)dihydroxyl compound include dimethylol propionic acid and dimethylol butanoic acid. Particularly preferred is dimethylol butanoic acid.

Examples of (e) polyol compound used in the present invention include polyether diols such as polyethylene glycol, polypropylene glycol and polytetramethylene glycol, polyester polyol which is obtained from an ester of polyhydric alcohol and polybasic acid, polycarbonate diols containing a structural unit derived from hexamethylene carbonate, pentamethylene carbonate or the like, and polylactone diols such as polycaprolactone diol and polybutyrolactone diol. Among these, polycarbonate diol is preferred.

Further, in a case where polymer polyol having carboxyl group is used, for example, a compound having a carboxyl group as a residue remaining after synthesis reaction which is conducted in the copresence of polybasic acid having three or more valences such as trimellitic acid (anhydride) so that such a residue will remain after the synthesis may be used.

The above polyol compounds need to have a number average molecular weight of 200 to 20,000. If the number average molecular weight is less than 200, flexibility of the film is deteriorated while if it exceeds 20,000, it causes decrease in developability.

Examples of (f) hydroxyl compound having a (meth)acryloyl group include 2-hydroxyethyl (meth)acrylate, hydroxypropyl (meth)acrylate, hydroxybutyl (meth)acrylate, caprolactones or alkylene oxide adducts of the foregoing (meth)acrylates, glycerin mono(meth)acrylate, glycerin di(meth)acrylate, glycidyl (meth)acrylate-acrylic acid adduct, trimethylolpropane mono(meth)acrylate, trimethylol di(meth)acrylate, pentaerythritol tri(meth)acrylate, dipentaerythritol penta(meth)acrylate, ditrimethylolpropane tri(meth)acrylate, trimethylolpropane-alkylene oxide adduct-di(meth)acrylate.

One kind of the above (f) hydroxyl compounds having a (meth)acryloyl group may be used singly or a combination of two or more kinds may be used. Among these, 2-hydroxyethyl (meth)acrylate, hydroxypropyl (meth)acrylate and hydroxybutyl (meth)acrylate are preferred, and 2-hydroxyethyl (meth)acrylate is particularly preferred.

Examples of (g) diisocyanate include diisocyanates such as 2,4-toluene diisocyanate, 2,6-toluene diisocyanate, isophorone diisocyanate, hexamethylene diisocyanate, diphenylmethylene diisocyanate, (o,m, or p)-xylene diisocyanate, methylenebis(cyclohexyl isocyanate), trimethylhexamethylene diisocyanate, cyclohexane-1,3-dimethylene diisocyanate, cyclohexane-1,4-dimethylene diisocyanate and 1,5-naphthalene diisocyanate. One kind of these diisocyanate may be used singly or a combination of two or more kinds may be used. Moreover, (g) diisocyanate having a carboxyl group may be used.

The urethane(meth)acrylateresin(B) used in the present invention can be prepared by
(1) a method where (d) dihydroxyl compound having a carboxyl group, (e) polyol compound, (f) hydroxyl compound having a (meth)acryloyl group and diisocyanate compound are mixed together all at once to react with each other,
(2) a method where after dihydroxyl compound (d), polyol compound (e) and (g) diisocyanate compound(g) are reacted to prepare a urethane isocyanate prepolymer having one or more isocyanato groups in one molecule, the urethane isocyanate prepolymer is reacted with hydroxyl compound (f),
(3) a method where after dihydroxyl compound (d) and diisocyanate compound (g) are reacted and further polyol compound (e) is allowed to react with diisocyanate compound (g) to prepare a urethane isocyanate prepolymer having one or more isocyanato groups in one molecule, this prepolymer is allowed to react with hydroxyl compound (f), and
(4) a method where after polyol compound(e) and diisocyanate compound(g) are reacted with each other and further dihydroxyl compound(d) is allowed to react with diisocyanate compound(g) to prepare a urethane isocyanate prepolymer having one or more isocyanato groups in one molecule, this prepolymer is allowed to react with hydroxyl compound (f).

It is preferable that the weight average molecular weight of the urethane(meth)acrylate resin(B) be from 1,000 to 100,000, more preferably from 8,000 to 30,000. If the weight average molecular weight is less than 1,000, it may cause deterioration of stretchability, flexibility and strength of the cured film. On the other hand, if it exceeds 100,000, it may cause curability and developability due to ultraviolet ray, which is not preferred.

The weight average molecular weight is a value in terms of polystyrene, measured by using gel permeation chromatography.

It is preferable that the acid value of the urethane(meth)acrylateresin(B) be from 5 to 150 mgKOH/g, more preferably 30 to 120 mgKOH/g. If the acid value is less than 5 mgKOH/g, reactivity with curable components may decrease, resulting in deterioration of heat resistance. On the other hand, if it exceeds 150 mgKOH/g, properties for resist material such as alkali resistance and electric properties of the cured film may decrease.

In the photosensitive resin composition of the present invention, single kind of urethane (meth)acrylateresin(B) is used or a mixture two or more kinds thereof is used. The blending amount of component(B) is preferably from 1 to 60 mass % in the composition, more preferably 3 to 45 mass %. If the amount of component (B) is less than 1 mass %, it may result in insufficient flexibility, moisture resistance and HHBT performance of the cured film. On the other hand, if it exceed 60 mass %, it tends to cause reduction in heat resistance and pencil hardness.

In the present Description, the acid value of the resin is value measured by the following method.

About 0.2 g of a sample is weighed by using a precision balance and charged into a 100-ml Erlenmeyer flask. To this, 10 ml of pyridine is added to be dissolved therein. Further, 1 to 3 drops of phenolphthaleine ethanol as indicator is added into the flask, and the mixture is stirred well until the sample becomes uniform. The resultant mixture is titrated with 0.05-N potassium hydroxide-ethanol solution, and the time point when the subtle red of the indicator has continued for 30 seconds is determined as the end point of neutralization. A value obtained from calculation by plugging the results in the following formula is determined as the acid value of the resin.
Acid Value (mg KOH/g)=[B×f×5. 6 1 1]/S
B: amount of 0.05N potassium hydroxide-ethanol solution (ml)
f: factor of 0.05N potassium hydroxide-ethanol solution
S: amount of collected sample (g)

Epoxy resin(C) used in the present invention is an epoxy resin having two or more three-membered ring or four-membered ring ethers in one molecule. Examples of the epoxy resin, though not particularly limited, include epoxy compounds having two or more epoxy groups such as bisphenol A-type epoxy resin, hydrogenated bisphenol A-type epoxy resin, brominated bisphenol A-type epoxy resin, bisphenol F-type epoxy resin, novolak-type epoxy resin, phenol novolak-type epoxy resin, cresol novolak-type epoxy resin, N-glycidyl-type epoxy resin, bisphenol A novolak-type epoxyresin, chlate-type epoxy resin, glyoxal-type epoxy resin, amino group-containing epoxy resin, rubber-modified epoxy resin, dicyclopentadienphenolic-type epoxy resin, silicone-modified epoxy resin and ε-caprolactone-modified epoxy resin. In addition, for the purpose of imparting flame retardancy, an epoxy resin where halogen atoms such as chlorine and bromine, phosphorous atom or the like is introduced into the structure in the bonding state that the atom is hardly decomposed by heat or water may be used. Further, bisphenol S-type epoxy resin, diglycidyl phthalate resin, heterocyclic epoxy resin, bixylenol-type epoxy resin, biphenol-type epoxy resin, tetraglycidyl xylenoyl ethane resin or the like may be used.

In the photosensitive resin composition of the present invention, single kind of epoxy resin (C) is used or a mixture of two or more kinds thereof is used. The blending amount of component(C) is preferably from 1 to 50 mass % in the composition, more preferably 3 to 40 mass %. If the amount of component (C) is less than 1 mass %, it may result in insufficient heat resistance, pencil hardness and HHBT performance of the cured film. On the other hand, if it exceed 50 mass %, it tends to cause reduction in flexibility of the cured film.

Examples of diluent(D) used in the present invention include, in addition to organic solvents, photopolymerizable monomer usable as reactive diluent, which also serves as solvent.

Examples of organic solvents include ketones such as ethyl methyl ketone and cyclohexanone, aromatic hydrocarbons such as toluene, xylene and tetramethylbenzene, glucol ethers such as methyl cellosolve, butyl cellosolve, methylcarbitol, butyl carbitol, propyleneglycol monomethylether, dipropyleneglycol monoethylether, dipropyleneglycol diethylether and triethyleneglycol monoethylether, esters such as ethyl acetate, butyl acetate, butyl cellosolve acetate and carbitol acetate, alcohols such as ethanol, propanol, ethylene glycol and propylene glycol, aliphatic hydrocarbons such as octane and decane, petroleum-base solvents such as petroleum ether, petroleum naphtha, hydrogenated petroleum naphtha and solvent naphtha.

On the other hand, examples of photopolymerizable monomer which is a reactive diluent also serving as solvent include hydroxyalkyl (meth)acrylates such as 2-hydroxyethyl (meth)acrylate and 2-hydroxypropyl(meth)acrylate, glycol mono-or di-(meth) acrylates such as ethylene glycol, methoxytetraethylene glycol and polyethylene glycol,(meth)acrylamides such as N,N-dimethyl (meth)acrylamide and N-methylol (meth)acrylamide, aminoalkyl (meth)acrylates such as N,N-dimethylaminoethyl (meth)acrylate, polyhydric alcohols such as hexanediol, trimethylolpropane, pentaerythritol, ditrimethylolpropane, dipentaerythritol and tris-hydroxyethyl isocyanurate or poly(meth)acrylates of ethylene oxide or propylene oxide adducts thereof, (meth)acrylates of ethylene oxide or propylene oxide adducts of phenols such as phenoxyethyl (meth)acrylate and polyethoxy of bisphenol A di(meth)acrylate, (meth)acrylates of glycidyl ethers such as glycerine diglycidyl ether, trimethylolpropane triglycidyl ether and triglycidyl isocyanurate, ε-caprolactone-modified (meth)acrylates such as caprolactone-modified tris(acryloxyethyl)isocyanurate and melamine(meth)acrylate.

Single kind of the diluent(D) is used or a mixture of two or more kinds thereof is used. It is preferable that the diluent be used in such an amount that the viscosity of the resin composition may be from 0.5 to 500 Pa·s, more preferably 10 to 300 Pa·s.

The ratio of the diluent in the photosensitive resin composition is from 5 to 80 mass %, particularly preferably 10 to 70 mass %.

In the present Description, viscosity is a value measured according to JISK5400 under a temperature of 25° C.

Examples of photopolymerization initiator(E) used in the present invention include benzophenones such as benzophenone, benzoyl benzoic acid, 4-phenylbenzophenone, hydroxybenzophenone and 4,4′-bis(diethylamino)benzophenone, benzoin alkyl ethers such as benzoin, benzoin ethylether, benzoin isopropyl ether, benzoin butyl ether and benzoin isobutyl ether, acetophenones such as 4-phenoxydichloroacetophenone, 4-t-butyl-dichloroacetophenone, 4-t-butyl-trichloroacetophenone, diethoxyacetophenone and 2-benzyl-2-dimethylamino-1-(4-morpholinophenyl)butanone-1, thioxanthenes such as thioxanthene, 2-chlorothioxanthene, 2-methylthioxanthene and 2,4-dimethylthioxanthene, alkyl anthraquinones such as ethylanthraquinone and butylanthraquinone, acylphosphine oxide such as 2,4,6-trimethylbenzoyldiphenylphosphine oxide, benzyl dimethyl ketal such as 2,2-dimethoxy-1,2-diphenylethane-1-one, α-aminoketones such as 2-methyl-1-[4-(methylthio)phenyl]-2-morpholinopropan-1-one and 2-benzyl-2-dimethylamino-1-(4-morpholinophenyl)butanone-1, a-hydroxyketones such as 2-hydroxy-2-methyl-1-phenyl-propane-1-one and 1-[4-(2-hydroxyethoxy)phenyl]-2-hydroxy-2-methylpropane-1-one, and 9,10-phenanthrenequinone. One of these compounds may be used singly or a mixture of two or more kinds may be used.

Among these photopolymerization initiators(E), benzophenones, acetophenones, acylphosphine oxide, α-aminoketones and α-hydroxyketones are preferred, and particularly, 4,4′-bis(diethylamino)benzophenone, 2-benzyl-2-dimethylamino-1-(4-morpholinophenyl)butanone-1,2,4,6-trimethylbenzoyldiphenylphosphine oxides, 2-methyl-1-[4-(methylthio)phenyl]-2-morpholinopropan-1-one and 2-benzyl-2-dimethylamino-1-(4-morpholinophenyl)-butanone-1,1-hydroxycyclohexyl phenyl ketone are more preferred for its efficient wavelength absorption and high activity.

It is preferable that the blending amount of the photopolymerization initiator(E) be from 0.1 to 20 mass parts based on the total 100 mass parts of photocurable components in the photosensitive resin composition, more preferably 0.2 to 10 mass parts. If the blending amount is less than 0.1 mass parts, it may result in insufficient curing of the photosensitive composition in some cases. On the other hand, if it exceeds 20 mass parts, solvent resistance and flexibility decrease, which is not preferred.

Here, the term “photocurable components” means, among component(A),component(B), diluent(D) and other additives added as appropriate, components having a photopolymerizable functional group such as (meth)acrylate.

In a case where curing through polymerization is conducted by ultra-violet ray using photopolymerization initiator, for the purpose of enhancing the polymerization rate, a photosensitizing agent may be used as appropriate. Examples of the photosensitizing agent used for such a purpose include pyrene, perylene, 2,4-diethylthioxanthone, 2,4-dimethylthioxanthone, 2,4-dichlorothioxanthone and phenothiazine. In a case where photosensitizing agent is used, the amount of the photosensitizing agent is preferably within a range of 0.1 to 100 mass parts based on 100 mass parts of photopolymerization initiator.

In the photosensitive resin composition of the present invention, for the purpose of enhancing HHBT performance, inorganic ion exchangers may be added. Examples of inorganic ion exchanger (F) used in the present invention include aluminosilicates such as natural zeolite and synthetic zeolite, metal oxides such as aluminium oxide and magnesium oxide, hydroxides and hydrated oxides such as hydrated titanium oxide, hydrated bismuth oxide and hydrated antimony oxide, acid salts such as zirconium phosphate and titanium phosphate, basic salts such as hydrotalcites or hydrated composite oxides, heteropolyphosphoric acids such as ammonium molybdophosphate and hexacyanoferrate (III). Among these, particularly preferred are hydroxides and hydrated oxides having high heat resistance, chemical resistance and moisture resistance, and specifically speaking, hydrated titanium oxide, hydrated bismuth oxide and hydrated antimony oxide are preferred.

It is preferable that the ion exchanger used in the present invention have a cation-exchanging ability of 0.1 meq/g or more in terms of Na ion and/or an anion-exchanging ability of 0.1 meq/g or more in terms of Cl ion. If the ion-exchanging ability is less than 0.1 meq/g, a large amount of the ion exchanger is required, resulting in deterioration of mechanical strength, flexibility and the like of the cured product. Moreover, one of these ion exchangers may be used singly or a mixture of two or more kinds may be used.

In the photosensitive resin composition of the present invention, for the purpose of enhancing heat resistance, flame retardancy, hardness, fluidity (thixotropic property, viscosity and the like), if necessary, conventionally curing agent, flame retardant, inorganic filler, organic filler, wax and surfactant can be further added.

Examples of curing agent include conventionally used known curing agent and curing promoters such as imidazole derivatives manufactured by Shikoku Corp. such as 2MZ, 2E4MZ, C₁₁Z, C₁₇Z, 2PZ, 1B2MZ, 2MZ-CN, 2E4MZ-CN, C₁₁Z-CN, 2PZ-CN, 2PHZ-CN, 2MZ-CNS, 2E4MZ-CNS, 2PZ-CNS, 2MZ-AZINE, 2E4MZ-AZINE, C₁₁Z-AZINE, 2MA-OK, 2P4MHZ,2PHZ and 2P4BHZ; guanamines such as acetoguanamine and benzoguanamine; polyamines such as diaminodiphenylmethane, m-phenylenediamine, m-xylenediamine, diaminodiphenylsulfone, dicyanediamide, urea, urea derivatives, melamine and polybasic hydrazide; organic acids and/or epoxy adducts of those compounds; amine complex of boron trifluoride; triazine derivatives such as ethyl diamino-S-triazine, 2,4-diamino-S-triazine and 2,4-diamino-6-xylyl-S-triazine; amines such as trimethylamine, triethanolamine, N,N-dimethyloctylamine, N-benzyldimethylamine, pyridine, N-methylmorpholine, hexa(N-methyl)melamine, 2,4,6-tris(dimethylaminophenol), tetramethylguanidine and m-aminophenol; polyphenols such as polyvinylphenol, brominated polyvinylphenol, phenol novolak and alkylphenol novolak; organic phosphines such as tributyl phosphine, triphenyl phosphine, tris-2-cyanoethyl phosphine; phosphonium salts such as tri-n-butyl (2,5-dihydroxyphenyl)phosphonium bromide, hexadecyltributyl phosphonium chloride; quaternary ammonium salts such as benzyl trimethylammonium chloride and phenyltributylammonium chloride; acid anhydride of the above described polybasic compounds; photo-cationic polymerization catalysts such as diphenyl iodonium tetrafluoroboroate, triphenylsulfonium hexafluoroantimonate, 2,4,6-triphenylthiopyrylium hexafluorophosphate, IRGACURE 261 manufactured by Nihon Ciba-Geigy K.K. and Optomer-SP-170 manufactured by Asahi Denka Co., Ltd.; styrene-maleic acid anhydride resin; and product of reaction between phenylisocyanate and dimethylamine in mol equivalents and product of reaction between organic polyisocyanate such as trilenediisocyanate or isophoronediisocyanate and dimethylamine in mol equivalents.

Examples of flame retardant include bromine-containing compounds such as brominated epoxy compound, acid-modified brominated epoxy compound, brominated epoxy compound having an acryloyl group and acid-modified brominated epoxy compound having an acryloyl group, inorganic flame retardants such as red phosphorous, tin oxide, antimony-based compound, zirconium hydroxide, barium methaborate, aluminum hydroxide and magnesium hydroxide and phosphor-based compounds such as ammonium phosphate compound, phosphate compound, aromatic condensed phosphoric acid ester, halogen-containing condensed phosphoric acid ester, nitrogen-containing phosphorous compound and phosphazene compound.

Examples of inorganic filler usable in the present invention include conventionally used known inorganic fillers such as barium sulfate, barium titanate, silicon oxide powder, silicone oxide fine powder, crystalline silica, amorphous silica, talc, clay, magnesium carbonate, calcium carbonate, aluminum oxide, aluminum hydroxide and mica powder. Examples of organic fillers include silicone resin, silicone rubber and fluorine resin.

Examples of wax include polyamide wax and polyethylene oxide wax. Examples of surfactants include silicon oil, higher fatty acid ester and amide.

Further, if necessary, conventionally used known polymerization inhibitors such as hydroquinone, hydroquinone monomethylether, tert-butylcathecol, pyrrogarrole and phenothiazine, viscosity improver such as silica, asbestos, Oruben, bentonite and montmorillonite, and conventionally used known additives such as defoaming and/or leveling agent based on silicone, fluorine, acryl or polymer, and adhesiveness-imparting agents such as silane-coupling agents based on imidazole, thiazole or triazole may be used. In addition, other additives, for example, ultraviolet rays protective agents or plasticizers may be added for the purpose of increasing the storage stability within a range that the amount does not affect features of the present invention.

Furthermore, copolymers of ethylenically unsaturated compounds such as acrylic acid esters, conventionally used known binder resins such as polyester resins synthesized from polyhydric alcohol and polybasic acid compound and photopolymerizable monomers or oligomers such as polyester (meth)acrylate, polyurethane (meth)acrylate and epoxy(meth)acrylate may be added to the composition within a range that the addition does not affect properties of the composition. These compounds are sometimes used as reactive diluent as above described.

For the purpose of reducing inflammability of the photosensitive resin composition of the present invention, water may be added. In a case where water is added, it is preferable that components (A) and (B) be rendered water-soluble by converting a carboxyl group of components (A) and (B) into a salt with amines such as trimethylamine and triethylamine, (meth)acrylate compounds having a tertiary amino group such as N,N-dimethylaminoethyl (meth)acrylate, N,N-dimethylaminopropyl (meth)acrylamide, N,N-dimethyl (meth)acrylamide, acryloylmorpholine, N-isopropyl(meth)acrylamide or N-methylolacrylamide.

The photosensitive resin composition of the present invention can be obtained by uniformly blending the above components by a conventional manner. The mixing method is not particularly limited. The method may be that after some of the components are mixed together, the other components are mixed therein. Alternatively, all the components are mixed together all at once. As the mixing apparatus, a known mixer, for example, a resolver, a roll mill, a beads mill or the like can be employed.

The photosensitive resin composition of the present invention, which is especially useful for resist ink, can be used as paint, coating agent, adhesive agent and the like. In a case where the composition of the present invention is used as resist ink, examples of substrate coatable with the composition include polyimide film, phenol resin laminated board and glass-epoxy resin coated board. Since the cured product of the present invention is excellent in flexibility, it is suitable for coating a flexible board having polyimide film or the like as its base material.

In preparation of resist ink composition, for example, a cured product is obtained by the following curing procedures. That is, onto a flexible printed wiring board, the photosensitive resin composition of the present invention is applied to have a film thickness of 5 to 160 μm by screen printing method, spraying method, roll coating method, static coating method, curtain coating method or the like. The film is dried by heat treatment at a temperature range of 60 to 100° C. for 5 to 30 minutes. Then after the film is exposed to light through a negative mask having an exposure pattern as desired, the unexposed portions are removed with an alkali developer and the film is washed with tap water or the like. The curing is conducted, for example, by heat treatment at a temperature range of 100 to 180° C. for 10 to 60 minutes. The composition of the present invention, when cured, is particularly excellent in flexibility and is especially suitable for an insulative film protecting an FPC substrate to make the FPC film excellent in handleability. Further, the composition may be used as insulative resin films present between layers of multi-layered circuit board.

Examples of the active light used in light exposure include those from known light sources such as carbon arc, mercury vapor arc and xenone arc. Usually, the photosensitivity of photopolymerization initiator(E) contained in the photosensitive layer is highest in the ultraviolet region, and therefore usually the light source is preferably one which effectively irradiates ultraviolet ray. Needless to say, in a case where photopolymerization initiator(E) is sensitive to visual light, for example, 9,10-phenanthrenequinone, visual light is used as active light and flood bulb for photography, solar lamp or the like can be used as its light source other than the above described light source.

Further, as developing solution, alkali solution including potassium hydroxide, sodium hydroxide, sodium carbonate, potassium carbonate, sodium phosphate, sodium silicate, ammonia, or amines can be used.

### BEST MODE FOR CARRYING OUT THE INVENTION

The present invention will now be explained in more detail with reference to the following examples, but is by no means limited thereto.

### Production Example 1

Production of Epoxy (Meth)acrylate Resin (EPA-1) as Component (A)

286 g of Bisphenol F-type epoxy resin (epoxy equivalent: 500 g/equivalent; softening point: 60° C.) was dissolved in 925 g of epichlorohydrin and 462.5 g of dimethylsulfoxide. To this was added 52.8 g of 98.5% sodium hydroxide over 100 minutes while stirring at 70° C.

After the addition, the reaction was continued for another 3 hours at 70° C. Then, excessive unreacted epichlorohydrin and most of dimethylsulfoxide were distilled off under a reduced pressure. The reaction product containing by-produced salt and dimethylsulfoxide was dissolved in 750 g of methylisobutyl ketone, and 10 g of 30 mass % sodium hydroxide aqueous solution was further added thereto to cause reaction for 1 hour at 70° C.

After completion of the reaction, the obtained solution was washed with 200 g of water twice and oil and water were separated from each other. Then, methylisobutyl ketone was recovered by distillation from the oil layer to obtain 320 g of epoxy prepolymer (a-1) (epoxy equivalent: 260; hydrolysable chlorine content: 0.08%; softening point: 52° C.; melt viscosity: 5.0 mPa·s (150° C.))

2600 g (10 equivalent) of the obtained epoxy prepolymer (a-1), 720 g (10 equivalent) of acrylic acid, 2.8 g of methylhydroquinone and 1943.5 g of carbitol acetate were mixed and heated to 90° C. while stirring to dissolve the reaction mixture. Next, the reaction solution was cooled to 60° C. and 16.6 g of triphenylphosphine was added thereto. The reaction solution was heated to 100° C. and reaction was continued for about 32 hours to thereby obtain a reaction product with an acid value of 1.0 mg KOH/g. Then, 1191 g (7.83 mol) of tetrahydrophthalic anhydride and 421.6 g of carbitol acetate were added to the reaction product, and the mixture was heated to 95° C. After conducting reaction for about 6 hours, the resultant mixture was cooled. Then the mixture was diluted with carbitol acetate to a solid concentration of 65% to thereby obtain epoxy (meth)acrylate resin (hereinafter referred to as EPA-1) having a viscosity of 40 Pa·s (25° C.). The obtained EPA-1 had a weight average molecular weight of 11,000 and an acid value of solid content of 100 mgKOH/g.

The average molecular weight was estimated by gel carrier liquid chromatography measurement (GPC; GPC-1 manufactured by Showa Denko K.K.) and calculated in terms of polystyrene.

### PRODUCTION EXAMPLE 2

Production of Epoxy (Meth)acrylate Resin (EPA-2) as Component (A)

269 g of Bisphenol A-type epoxy resin (epoxy equivalent: 470 g/equivalent; softening point: 54° C.) was dissolved in 925 g of epichlorohydrin and 462.5 g of dimethylsulfoxide. To this was added 52.8 g of 98.5% sodium hydroxide over 100 minutes while stirring at 70° C.

After the addition, the reaction was continued for another 3 hours at 70° C. Then, excessive unreacted epichlorohydrin and most of dimethylsulfoxide were distilled off under a reduced pressure. The reaction product containing by-produced salt and dimethylsulfoxide was dissolved in 750 g of methylisobutyl ketone, and 10 g of 30 mass % sodium hydroxide aqueous solution was further added thereto to cause reaction for 1 hour at 70° C.

After completion of the reaction, the obtained solution was washed with 200 g of water twice and oil and water were separated from each other. Then, methylisobutyl ketone was recovered by distillation from the oil layer to thereby obtain 300 g of epoxy prepolymer (a-2) (epoxy equivalent: 250; hydrolysable chlorine content: 0.05%; softening point: 58° C.; melt viscosity: 5.7 mPa·s (150° C.)). The obtained 2500 g (10 equivalent) of epoxy prepolymer (a-2), 720 g (10 equivalent) of acrylic acid, 2.8 g of methylhydroquinone, 1943.5 g of carbitol acetate were mixed and heated to 90° C. while stirring to dissolve the reaction mixture. Next, the reaction solution was cooled to 60° C. and 16.6 g of triphenylphosphine was added thereto. Then the mixture was heated to 100° C. and the reaction was conducted for about 32 hours to thereby obtain a reaction product with an acid value of 1.0 mg KOH/g. Then, 1191 g (7.83 mol) of tetrahydrophthalic anhydride and 421.6 g of carbitol acetate were added to the reaction product, and the mixture was heated to 95° C. After conducting reaction for about 6 hours, the resultant mixture was cooled. The mixture was diluted with carbitol acetate to a solid concentration of 65% to thereby obtain epoxy (meth)acrylate resin (hereinafter referred to as EPA-2) having a viscosity of 40 Pa·s (25° C.). The obtained EPA-2 had a weight average molecular weight of 10,000 and an acid value of solid content of 100 mgKOH/g.

### PRODUCTION EXAMPLE 3

Production of Epoxy (Meth)acrylate Resin (EPA-3) as Component (A)

The epoxy (meth)acrylate resin (hereinafter referred to as EPA-3) having a viscosity of 21 Pa·s (25° C.) was obtained in the same manner as in Production Example 2 except that 783 g (7.83 mol) of succinic acid anhydride was used as acid anhydride (c) in place of tetrahydrophthalic anhydride. The obtained EPA-3 had a weight average molecular weight of 9,000 and an acid value of solid content of 100 mgKOH/g.

### PRODUCTION EXAMPLE 4

Production of Urethane (Meth)acrylate Resin (PUA-1) as Component (B)

Into a reaction vessel equipped with a stirrer, a thermometer and a condenser, 3750 g (3 mol) of polycaprolactonediol (manufactured by Daicel Chemical Industries, Ltd.; trade name: PLACCEL 212; average molecular weight: 1250) as polyol compound (e), 445 g (3 mol) of dimethylol butanoic acid as dihydroxyl compound having a carboxyl group (d), 1554 g (7 mol) of isophorone diisocyanate as diisocyanate compound (g), 238 g (2.05 mol) of 2-hydroxyethyl acrylate as hydroxyl compound (f) and 1.0 g of each of p-methoxyphenol and di-t-butyl-hydroxytoluene were charged. After the mixture was heated to 6020 C. while stirring and then the heating was stopped, 1.6 g of dibutyl tin dilaurate was added to the mixture. When the temperature inside the reaction vessel started to decrease, the mixture was heated again and stirring was continued at 80° C. Then, when disappearance of absorption of isocyanate group (2280 cm⁻¹) was confirmed in infrared absorption spectrum, the reaction was terminated. The reaction product was diluted with carbitol acetate to a solid concentration of 50% to thereby obtain urethane (meth)acrylate resin (hereinafter referred to as PUA-1) having a viscosity of 10 Pa·s (25° C.). The obtained PUA-1 had a weight-average molecular weight of 15,000 and an acid value of solid content of 47 mgKOH/g.

### PRODUCTION EXAMPLE 5

Production of Urethane (Meth)acrylate Resin (PUA-2) as Component (B)

The urethane (meth)acrylate resin (hereinafter referred to as PUA-2) having a viscosity of 8 Pa·s (25° C.) was obtained in the same manner as in Production Example 4 where the reaction mixture was diluted with carbitol acetate to a solid concentration of 50%, except that 2550 g (3 mol) of polytetramethylene glycol (manufactured by Hodogaya Chemical Co., Ltd.; trade name: PTMG-850; average molecular weight: 850) was used as polyol compound (e) and 1316 g (7 mol) of xylylene diisocyanate as diisocyanate compound (g) were used. The obtained PUA-2 had a weight average molecular weight of 14,000 and an acid value of solid content of 44 mgKOH/g.

### PRODUCTION EXAMPLE 6

Production of Acrylic Acid Ester Oligomer (EA-1) as Component (D) (Reactive Diluent)

2500 g (10 equivalent) of the epoxy prepolymer (a-2) obtained in Production Example 2, 720 g (10 equivalent) of acrylic acid, 2.8 g of methylhydroquinone and 1943.5 g of carbitol acetate were mixed and the mixture was heated to 90° C. while stirring to dissolve the reaction mixture. Next, the reaction solution was cooled to 60° C. and 16.6 g of triphenylphosphine was added thereto, and then heated to 100° C. The reaction was continued for about 32 hours to thereby obtain a reaction product with an acid value of 1.0 mg KOH/g. Then, the reaction product was diluted with carbitol acetate to a solid concentration of 70% to thereby obtain acrylic ester oligomer (hereinafter referred to as EA-1) having a viscosity of 35 Pa·s (25° C.). The obtained EA-1 had a weight-average molecular weight of 7,000.

Preparation of Photosensitive Resin Composition:

Commercially available products used in the following Examples and Comparative Examples of the photosensitive resin composition are as follows.

Epoxy Resin (C)

(1) YX-4000: tetramethyl biphenol-type epoxy resin (trade name; manufactured by Yuka Shell Epoxy K.K.).
   Diluent (D)
(1) DPHA: 6functional acrylic ester monomer (KAYARAD DPHA; trade name; manufactured by NIPPON KAYAKU CO.,LTD.),
(2) UA-200AX: 2functional urethane acrylate oligomer (manufactured by Shin-nakamura Chemical CO., LTD.),
(3) carbitol acetate: manufactured by Daicel Chemical Industries,
(4) #8500: Mixture of carbitol acetate and petroleum naphtha manufactured by Nippon Polytech CO.,LTD.
   Photopolymerization Iitiator (E)
(1) IRGACURE907: 2-methyl-1-[4-(methylthio)phenyl]-2-morpholinopropane-1-one (manufactured by Ciba Specialty Chemicals K.K.),
(2) DETX: 2,4-diethylthioxanthone (manufactured by NIPPON KAYAKU CO.,LTD.).
   Inorganic Ion Exchanger (F)
(1) IXE-100: cation exchanger; 6.6 meq/g of sodium ion content (manufactured by TOAGOSEI CO., LTD.),
(2) IXE-500: anion exchanger; 3.9 meq/g of chlorine ion content (manufactured by TOAGOSEI CO., LTD.),
   Filler
(1) barium sulfate: manufactured by SAKAI CHEMICAL INDUSTRY CO.,LTD.
(2) silica: AEROSIL (trade name; manufactured by NIPPON AEROSIL CO.,LTD).
   Curing Agent
(1) dicyandiamide: manufactured by NIPPON CARBIDE INDUSTRIES CO.,INC.

### EXAMPLES 1 to 6 AND COMPARATIVE EXAMPLES 1 to 3

A photosensitive resin composition was prepared by mixing each component at a ratio (mass %) as shown in Table 1, using three roll mill having 4 inch diameter (manufactured by INOUE MFG., INC.) under a condition of mixing temperature 23° C. All the obtained compositions had a viscosity of 23 Pa·s.

Each of the obtained compositions was coated on a substrate for evaluation (a polyimide substrate with a copper foil having a copper thickness of 12 μm attached thereto) by screen printing method to a post-cure thickness of 20 to 25 μm and, then dried using a hot-air dryer for 30 minutes at 70° C. Thereafter, the coating film was left to be cooled to room temperature to thereby obtain a sample piece for evaluation. Then, each of the obtained sample pieces was evaluated on photosensitivity, developability, and flexibility.

[Photosensitivity]

The sample piece for evaluation was lapped over with step tablet (trade name: Photec; manufactured by Hitachi chemical CO.,LTD.; 21-step tablet) and exposed to light through the step tablet with metal halide lamp (0.5 J/cm², wavelength 365 nm conversion, scattering light). Thereafter, the sample was developed for 1 minutes using 1 mass % sodium carbonate aqueous solution having a temperature of 30° C. at a spray pressure of 0.2 Mpa. The sample was further washed with 30° C. water for 1 minute at a spray pressure of 0.2 Mpa and thereafter, subjected to thermal treatment using a hot-air dryer for 30 minutes at 150° C. to thereby obtain a cured product. Photosensitivity of the photosensitive composition was evaluated by measuring the step number of the cured product remaining on the substrate. Photosensitivity was indicated by step number, and the larger the step number, the higher photosensitivity it indicates.

[Developability]

The sample piece for evaluation was developed for 1 minutes using 1 mass % sodium carbonate aqueous solution having a temperature of 30° C. at a spray pressure of 0.2 Mpa. After developing, the degree of the resin composition remaining on the substrate was evaluated by visual observation as the following 3 levels.
ο: no remaining resin composition was observed
Δ:only a little remaining resin composition was observed
X :the resin composition remained
   [Flexibility]

The sample piece for evaluation was exposed to light with metal halide lamp (0.5 J/cm², wavelength 365 nm conversion, scattering light) without masking and, thereafter, the sample was developed for 1 minutes using 1 mass % sodium carbonate aqueous solution having a temperature of 30° C. at a spray pressure of 0.2 Mpa. The sample was further washed with 30° C. water for 1 minute at a spray pressure of 0.2 Mpa and, then, subjected to thermal treatment using a hot-air dryer for 30 minutes at 150° C. to thereby obtain a cured product. The obtained cured product was bended at 180° and a pressure of 0.5 Mpa was applied thereto. In order to evaluate flexibility, the degree of cracking was judged by microscopic observation as the following 3 levels.
ο:no crack was observed
Δ:only a few cracks were observed
X :considerable cracks were observed
   [High temperature, High humidity Bias Test (HHBT Performance)]

A copper circuit having a comb-shaped pattern (line/space=100/100 μm) for HHBT evaluation, was formed on the aforementioned substrate by a known method to thereby prepare a substrate for HHBT test. The photosensitive resin composition of the present invention was coated on the substrate for HHBT test by screen printing method so that the coating film had a post-cure thickness of 20 to 25 μm and, then dried using a hot-air dryer for 30 minutes at 70° C. Thereafter, the coating film was left to be cooled to room temperature and the obtained sample piece was subjected to the same operation as in the evaluation for flexibility described above to obtain a cured product serving as a sample piece for HHBT test. The obtained sample piece for HHBT test was examined under a condition of temperature of 85° C., humidity of 85% RH and direct voltage of 50V.

HHBT performance was evaluated as the following 3 levels by measuring resistance values between the wires after 1000 hours and by observing dendrites in the circuits using a microscope.

TABLE 1

| | | | | blending amount: mass % | | | | | | |
|---|---|---|---|---|---|---|---|---|---|---|
| | | | | | | | | Comp. | Comp. | Comp. |
| Blended components | | Ex. 1 | Ex. 2 | Ex. 3 | Ex. 4 | Ex. 5 | Ex. 6 | Ex. 1 | Ex. 2 | Ex. 3 |
| A | EPA-1 (solid | 38.0 | | 38.0 | 38.0 | | 38.0 | 54.0 | 38.0 | |
| | content: 65 mass %) | | | | | | | | | |
| | EPA-2 (solid | | 38.0 | | | | | | | |
| | content: 65 mass %) | | | | | | | | | |
| | EPA-3 (solid | | | | | 38.0 | | | | 54.0 |
| | content: 65 mass %) | | | | | | | | | |
| B | PUA-1 (solid | 16.0 | 16.0 | 16.0 | 16.0 | 16.0 | | | | |
| | content: 50 mass %) | | | | | | | | | |
| | PUA-2 (solid | | | | | | 16.0 | | | |
| | content: 50 mass %) | | | | | | | | | |
| C | YX-4000 | 10.0 | 10.0 | 10.0 | 10.0 | 10.0 | 10.0 | 10.0 | 10.0 | 10.0 |
| D | #8500 | 4.0 | 4.0 | 4.0 | 4.0 | 4.0 | 4.0 | 4.0 | 4.0 | 4.0 |
| | EA-1 (solid | 12.5 | 12.5 | 12.5 | 12.5 | 12.5 | 12.5 | 12.5 | 12.5 | 12.5 |
| | content: 70 mass %) | | | | | | | | | |
| | DPHA | 3.5 | 3.5 | 3.5 | 3.5 | 3.5 | 3.5 | 3.5 | 3.5 | 3.5 |
| | UA-200AX | | | | | | | | 16.0 | |
| E | IRGAQURE 907 | 5.0 | 5.0 | 5.0 | 5.0 | 5.0 | 5.0 | 5.0 | 5.0 | 5.0 |
| | DETX-S | 0.5 | 0.5 | 0.5 | 0.5 | 0.5 | 0.5 | 0.5 | 0.5 | 0.5 |
| F | IXE-100 | | | 3.0 | | 3.0 | | | | |
| | IXE-500 | | | | 3.0 | | | | | |
| | barium sulfate | 8.0 | 8.0 | 5.0 | 5.0 | 5.0 | 8.0 | 8.0 | 8.0 | 8.0 |
| | silica | 1.5 | 1.5 | 1.5 | 1.5 | 1.5 | 1.5 | 1.5 | 1.5 | 1.5 |
| | dicyandiamide | 1.0 | 1.0 | 1.0 | 1.0 | 1.0 | 1.0 | 1.0 | 1.0 | 1.0 |
| Viscosity of photosensitive | | 23 | 23 | 23 | 23 | 23 | 23 | 23 | 23 | 23 |
| resin composition (Pa · s) | | | | | | | | | | |
| Evaluation | Photosensitivity | 8 | 9 | 8 | 8 | 8 | 10 | 9 | 9 | 9 |
| items | | | | | | | | | | |
| | Developability | ◯ | ◯ | ◯ | ◯ | ◯ | ◯ | ◯ | X | ◯ |
| | Flexibility | ◯ | ◯ | ◯ | ◯ | ◯ | ◯ | X | ◯ | Δ |
| | HHBT performance | ◯ | ◯ | ◯ | ◯ | ◯ | Δ | Δ | ◯ | X |

◯: resistance value between the wires was 108 Ω or more and no dendrite was observed
Δ: resistance value between the wires was 108 Ω or more and dendrites were generated
X: resistance value between the wires is less than 108 Ω and dendrites were generated

### INDUSTRIAL APPLICABILITY

The photosensitive resin composition according to the present invention is excellent in storage stability and cured product of the composition not only exhibits an excellent HHBT performance but also is excellent in flexibility, resistance to plating, chemicals and heat, photosensitivity, developability and plasticity. Therefore, a printed circuit board partially or wholly coated with the heat-cured product is suitably used in electronic devices using a flexible circuit board which requires high precision and flexibility.

1. A photosensitive resin composition comprising
(A) an epoxy(meth)acrylate resin synthesized from components containing (a) epoxy prepolymer, (b) an unsaturated group-containing monocarboxylic acid and (c) an acid anhydride,
(B) a urethane(meth)acrylate resin synthesized from components containing (d) a dihydroxyl compound having a carboxyl group, (e) a polyol compound having an number average molecular weight of 200 to 20,000, (f) a hydroxyl compound having a (meth)acryloyl group and (g) diisocyanate compound,
(C) an epoxy resin,
(D) a diluent and
(E) a photopolymerization initiator.

2. The photosensitive resin composition as claimed in claim 1, further comprising (F) an inorganic ion exchanger.

3. The photosensitive resin composition as claimed in claim 1, wherein the blending ratios of the components in the composition are 10 to 90 mass % for component
(A), 1 to 60 mass % for component (B), 3 to 40 mass % for component (C) and 5 to 80 mass % for component (D).

4. The photosensitive resin composition as claimed in claim 1, wherein the acid value of the epoxy(meth)acrylate resin (A) is in a range of 5 to 150 mgKOH/g and the weight average molecular weight of the epoxy(meth)acrylate resin (A) is in a range of 1,000 to 100,000.

5. The photosensitive resin composition as claimed in claim 1, wherein the acid value of the urethane(meth)acrylate resin (B) is in a range of 5 to 150 mgKOH/g and the weight average molecular weight the epoxy(meth)acrylate resin (B) is in a range of 1,000 to 100,000.

6. The photosensitive resin composition as claimed in claim 1, wherein the acid anhydride (c) contained in the epoxy(meth)acrylate resin (A) is tetrahydrophthalic anhydride.

7. The photosensitive resin composition as claimed in claim 1, wherein the dihydroxyl compound having a carboxyl group (d) contained in the urethane(meth)acrylate resin (B) is dimethylol butanoic acid.

8. The photosensitive resin composition as claimed in claim 1, wherein the polyol compound (e) contained in the urethane (meth)acrylate resin (B) is a polycarbonate diol.

9. The photosensitive resin composition as claimed in claim 1, wherein the epoxy resin (C) has two or more epoxy groups in one molecule.

10. The photosensitive resin composition as claimed in claim 1, wherein the viscosity at 25° C. is in a range of 0.5 to 500 Pa□s.

11. A heat-cured product of the photosensitive resin composition described in claim 1.

12. A solder resist comprising the heat-cured product described in claim 11.

13. A printed circuit board partially or wholly coated with the heat-cured product described in claim 11.

14. A resist ink comprising the photosensitive resin composition described in claim 1.
